(19) United States
(12) Patent Application Publication
(10) Pub. No.: US 2004/0111743 A1
(43) Pub. Date: Jun. 10, 2004

(54) Method for providing a broadcast with a discrete neighborhood focus

(76) Inventor: Craig T. Moncreiff, San Diego, CA (US)

Correspondence Address: David E. Heisey, Esq., Luce Forward Hamilton & Scripps LLP, Suite 200, 11988 El Comino Real, San Diego, CA, 92130, US

(21) Appl. No.: 10/315,602

(22) Filed: Dec. 9, 2002

(51) Int. Cl. H04N 7/173; H04N 7/10; H04N 7/025; H04N 7/16

(52) U.S. Cl. 725/35; 725/36; 725/116; 725/146

(57) ABSTRACT

A method of providing a broadcast for a designated geographic area includes the steps of obtaining information content for the broadcast from at least one media source, converting the information content into a broadcast format, identifying a selected market that is less than or equal to the source audience for the at least one media source and transmitting the information content to the selected market via a broadcast.

### FIELD OF THE INVENTION

The present invention is directed to broadcasts having a discrete, neighborhood focus.

### BACKGROUND OF THE INVENTION

Cable systems and television stations broadcast news, sports and other programming content to cities and areas covered by their cable lines or “over-the-air” broadcast systems. These broadcasts commonly encompass local, regional and national events and news as well as taped content provided by third party programmers. However, the broadcasts typically lack a local focus, thereby neglecting important neighborhood news stories and events.

An existing network of independent, local, and often free, weekly/periodic newspapers currently covers these local, neighborhood news stories and events on a dedicated basis. These newspapers uniquely contain much of the content that a local news broadcast would require.

In view of the above, there is a substantial need for a broadcast having a discrete, neighborhood focus.

### SUMMARY OF THE INVENTION

The present invention alleviates to a great extent the above-noted and other disadvantages by disclosing methods for providing a broadcast having a discrete neighborhood focus. The invention relates to sending audio/visual programming content to limited, designated geographic areas, specifically to neighborhoods within larger cities or communities.

One aspect of the present invention involves a method of providing a broadcast for a designated geographic area including the steps of obtaining content for the broadcast from at least one local media source, converting the content into a broadcast format, identifying a selected market that is less than or equal to the source audience for the at least one media source and transmitting the content to the selected market via a broadcast.

An additional aspect of the present invention involves a method of providing a broadcast for a designated geographic area including the steps of obtaining content for the broadcast from at least one local media source, obtaining further content from another local media source, integrating the content obtained from the local media sources, converting the content into a broadcast format, identifying a selected market that is less than or equal to the source audience for the at least one media source and transmitting the content to the selected market via a broadcast Another aspect of the present invention involves a method of providing a broadcast for a designated geographic area including the steps of obtaining content for the broadcast from at least one local media source, converting the content into a broadcast format, identifying a selected market that is less than or equal to the source audience for the at least one media source and transmitting the content to the selected market via a broadcast, wherein the broadcast is a cable television broadcast sent by a cable system to a targeted geographic area that is less than an overall geographic area covered by the cable system, wherein the targeted geographic area covers no more than 50,000 homes.

A further aspect of the present invention involves a method of providing a targeted television broadcast, including the steps of obtaining content for the television broadcast from at least one non-television media source, converting the content into a television broadcast format, identifying a selected market that is a subset of a television media broadcast market and transmitting the converted content to the selected market via a television broadcast.

Yet another further aspect of the present invention involves a method of providing a targeted television broadcast, including the steps of obtaining content for the television broadcast from at least one non-television media source, obtaining further content from another non-television media source, integrating the content obtained from the non-television media sources, converting the content into a television broadcast format, identifying a selected market that is a subset of a television media broadcast market and transmitting the converted content to the selected market via a television broadcast.

An additional aspect of the present invention involves a method of providing information to customers within a designated geographic area, including the steps of providing a physical home delivery of the information to the customers within the designated geographic area, converting the information into a broadcast format and transmitting the information to the customers within the designated geographic area.

These and other features and advantages of the present invention will be appreciated from review of the following detailed description of the invention, along with the accompanying figures in which like reference numerals refer to like parts throughout.

### BRIEF DESCRIPTION OF THE DRAWINGS

FIG. 1 is a flowchart of an embodiment of a method in accordance with the present invention; and

FIG. 2 is a flowchart of an embodiment of a method in accordance with the present invention.

### DETAILED DESCRIPTION OF THE PREFERRED EMBODIMENTS

In the following paragraphs, the present invention will be described in detail by way of examples with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

The present invention involves sending audio/visual programming content to limited, designated geographic areas. By combining and leveraging existing local non-broadcast media resources and content with the cable system's geographically segmented broadcasting ability, a new form of local broadcast is provided having a focus dedicated to the neighborhood marketplace. Local non-broadcast media such as newspapers are generally supported by classified, automobile, real estate and help wanted advertising. This type of advertising is best focused on the neighborhood marketplace. By broadcasting these advertisements to a local market, local advertisers can increase their neighborhood impact.

The present invention contemplates the geographic segmentation of programming including, but not limited to, news, sports and advertising, at the neighborhood level by a broadcast. Geographic segmentation can be accomplished using consumer self-selection, installation set-up set-top box encoding or other methods, and may further include pay-per-view or video on demand elements.

According to some embodiments of the present invention, local non-broadcast media partners will provide the information content and pay business management fees, advertising royalties, and carriage fees in exchange for the broadcaster's carriage contracts. The broadcasters will realize incremental new revenue per subscriber through carriage fees and shared advertising royalties. In addition, there will be new barriers to entry for potential competitors for the following reasons.

The local focus provided by the present invention cannot be duplicated by a larger satellite footprint, thereby creating a unique customer service. In addition, the broadcasters are afforded local programming content supporting their community outreach and promotional campaigns.

The benefits for the local media sources include additional revenue from leveraging existing content and the development of a broadcast presence. Leveraging existing content can be achieved by the resale of existing information content without additional effort spent on information gathering. The development of a broadcast presence can provide new promotional opportunities through advertisement as well as additional industry prestige and growth.

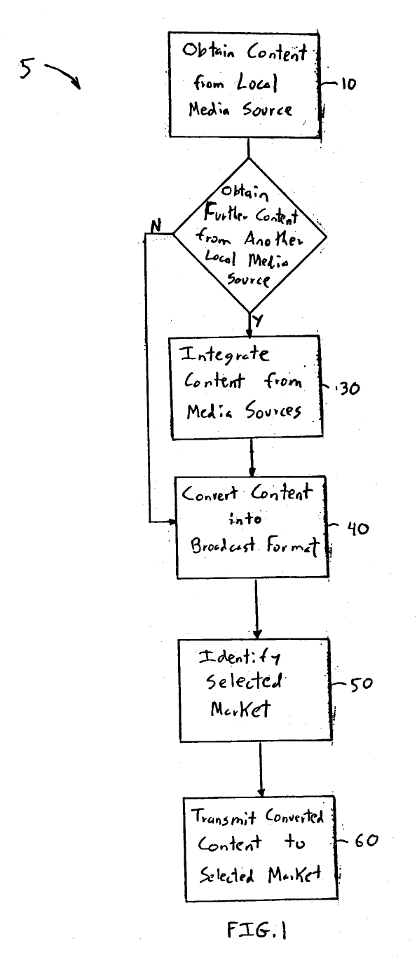

A method of providing a broadcast for a designated geographic area will now be described. As seen in FIG. 1, the method 5 begins with step 10, which involves information obtaining content for the broadcast from at least one local media source. The at least one local media source may include newspapers, magazines and other local publications. According to some embodiments, the at least one local media source is a non-broadcast media source such as a local newspaper distributed at a maximum of once per week. Step 20 comprises obtaining further information content from another local media source and step 30 comprises integrating the information content obtained from all local media sources. In some embodiments, obtaining further information content from another local media source involves gathering additional information content from a non-broadcast media source such as a local newspaper. Integrating the information content obtained from the local media sources involves combining and leveraging the content of the various local media sources to achieve a more thorough local broadcast dedicated to the neighborhood marketplace.

Step 40 comprises converting the information content obtained from the at least one local media source into a broadcast format. This step involves reformatting the local media information content as described below. The next step (step 50) comprises identifying a selected market that is less than or equal to the source audience for the at least one local media source. For example, assuming the at least one local media source is a local newspaper having a source audience of 50,000 homes, the selected market would include a targeted geographic area comprising any portion of the source audience up to, and including, all 50,000 homes. Step 60 involves transmitting the converted information content to the selected market via a broadcast. The broadcast may be a cable television, an “over the air” broadcast or an Internet broadcast.

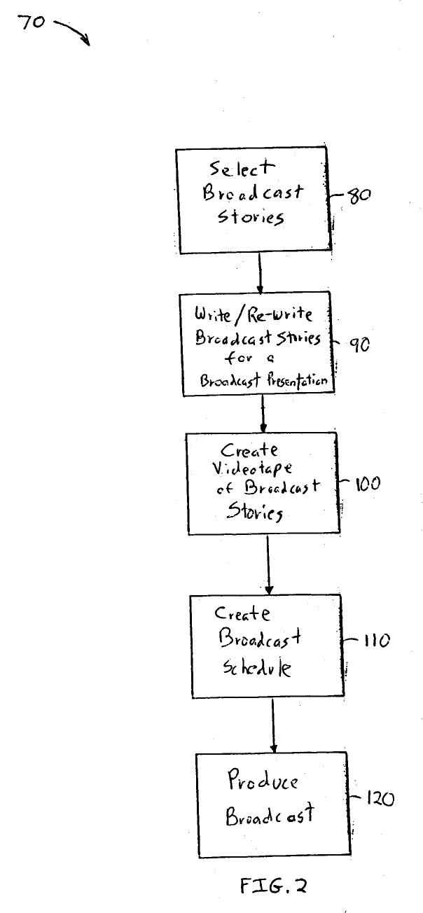

One step of the above method involves converting information content obtained from at least one local media source into a broadcast format. As seen in FIG. 2, a method 70 of converting information content obtained from at least one local media source into a broadcast format begins with step 80, which involves selecting broadcast stories from the local media source(s). Optionally, this step also involves selecting broadcast stories from a broadcast studio or newsroom. The broadcast stories may include headline news, opinions, weather, sports, special features, government issues, regular segments and other news.

The next step (step 90) involves writing and/or re-writing broadcast stories for a broadcast presentation. Step 100 involves creating a videotape of the broadcast stories, which may include videotaping news segments and inserting videotape segments from other broadcast studios or newsrooms. Optionally, step 100 may also include taping and/or inserting commercial videotape segments. Step 110 involves creating a broadcast schedule of the broadcast stories and step 120 involves producing a broadcast including the broadcast stories. The broadcast may be a television broadcast, such as a cable television broadcast or an “over the air” broadcast, or an Internet broadcast.

In some embodiments, customers are provided the same information content via a physical home delivery (i.e., a local newspaper) as well as the broadcast delivery (i.e., a television, Internet or “over the air” broadcast). In addition, the same advertisements can be promoted in both the local non-broadcast media and the local broadcast. This related broadcast advertising may relate to businesses within the targeted geographic area.

To cover a broad geographic region, a network of local media source to local broadcasts can be created using the above method. Further, a single broadcast studio can be employed to aggregate multiple broadcasts encompassing different geographic areas.

Thus, it is seen that a method of providing a broadcast with a discrete, neighborhood focus is provided. One skilled in the art will appreciate that the present invention can be practiced by other than the preferred embodiments which are presented in this description for purposes of illustration and not of limitation, and the present invention is limited only by the claims that follow. It is noted that equivalents for the particular embodiments discussed in this description may practice the invention as well.

What is claimed is:

1. A method of providing a broadcast for a designated geographic area, comprising the steps of:
obtaining information content for the broadcast from at least one media source;
converting the information content into a broadcast format;
identifying a selected market that is less than or equal to the source audience for the at least one media source; and
transmitting the information content to the selected market via a broadcast.

2. The method of claim 1, further comprising the steps of:
obtaining further information content from a second media source; and
integrating the information content obtained from the media sources.

3. The method of claim 1, wherein the broadcast is a cable television broadcast.

4. The method of claim 3, wherein the cable television broadcast is sent by a cable system to a targeted geographic area that is less than an overall geographic area covered by the cable system.

5. The method of claim 4, wherein the targeted geographic area covers no more than 50,000 homes.

6. The method of claim 1, wherein the broadcast is an Internet broadcast.

7. The method of claim 1, wherein the broadcast is an “over the air” broadcast.

8. The method of claim 1, wherein the step of converting the information content into a broadcast format includes the step of reformatting the media source information content.

9. The method of claim 1, wherein the at least one media source includes a newspaper.

10. The method of claim 9, wherein the newspaper is distributed no more than once per week.

11. The method of claim 2, wherein the media sources are non-broadcast media sources.

12. A method of providing a targeted television broadcast, comprising the steps of:
obtaining information content for the television broadcast from at least one non-television media source;
converting the information content into a television broadcast format;
identifying a selected market that is a subset of a television media broadcast market; and
transmitting the converted information content to the selected market via a television broadcast.

13. The method of claim 12, further comprising the steps of:
obtaining further information content from a second non-television media source; and
integrating the information content obtained from the non-television media sources.

14. The method of claim 12, wherein the television broadcast is a cable television broadcast.

15. The method of claim 12, wherein the at least one non-television media source includes a newspaper.

16. A method of providing information to customers within a designated geographic area, comprising the steps of:
providing a physical home delivery of the information to the customers within the designated geographic area;
converting the information into a broadcast format; and
transmitting the information to the customers within the designated geographic area.

17. The method of claim 16, wherein the designated geographic area covers no more than 50,000 homes.

18. The method of claim 16, wherein the broadcast is a cable television broadcast.

19. The method of claim 16, wherein the broadcast is an Internet broadcast.

20. The method of claim 16, wherein the broadcast is an “over the air” broadcast.

21. The method of claim 1, wherein the step of converting the information into a broadcast format includes the steps of:
selecting broadcast stories from the at least one local media source;
writing or re-writing broadcast stories for a broadcast presentation;
creating a videotape of the broadcast stories;
creating a broadcast schedule of the broadcast stories; and
producing a broadcast including the broadcast stories.

22. The method of claim 21, wherein the step of selecting broadcast stories from the at least one local media source includes the step of selecting broadcast stories from a broadcast studio or newsroom.

23. The method of claim 21, wherein the step of creating a videotape of the broadcast stories includes the step of videotaping news segments and inserting videotape segments from other broadcast studios or newsrooms.

24. The method of claim 21, wherein the step of creating a videotape of the broadcast stories includes the step of taping and inserting commercial videotape segments.
